(19) United States
(12) Patent Application Publication
(10) Pub. No.: US 2026/0369184 A1
(43) Pub. Date: Nov. 19, 2026

(54) CONTROL POINT DATA MANAGEMENT FOR A PLURALITY OF SURVEYING DEVICES

(71) Applicant: LEICA GEOSYSTEMS AG, Heerbrugg (CH)

(72) Inventor: Bernhard METZLER, Dornbirn (AT)

(73) Assignee: LEICA GEOSYSTEMS AG, Heerbrugg (CH)

(21) Appl. No.: 19/677,589

(22) Filed: May 14, 2026

(30) Foreign Application Priority Data
May 15, 2025 (EP) 25176621.8

(51) Int. Cl. G09B 25/06; G06T 7/70

(52) U.S. Cl. CPC G09B 25/06; G06T 7/70; G06T 2207/10028

(57) ABSTRACT

A surveying system for generating a point cloud representing a setting. The scene comprises a set of real-world objects. The system comprises a plurality of surveying devices and a data management server. The data management server stores a set of control points each associated with a unique ID and with pose data. The plurality of surveying devices comprises a first and a second surveying device. The first surveying device configured to generate a first control point associated with a first unique ID and the first control point position data, and to send said data for the data management server for an updating of an existing or a generation of a new set of control points. The second surveying device is configured to generate position data for a set of object points in the setting based on the scanning data and its pose data.

### FIELD

The present disclosure relates to a surveying system comprising a plurality of surveying instruments, particularly at least two different types of surveying instruments, and a data management server. The disclosure also relates to a method of data exchange between said components.

### BACKGROUND

To capture topographic information, in particular a surface of an object, in setting, in particular a building or a construction site, scanning methods are typically utilized. The topography is typically represented by a contiguous point cloud. A common method for scanning surfaces is the utilization of scanning instruments or modules, in particular laser scanners. The scanning instrument scans the surface of objects with a scanning beam, in particular laser-beam, and the topography is generated by combining the measured distance information with emission angles of the scanning beam.

Laser scanning instruments and methods for their utilization are known in the prior art and are disclosed for example in WO 97/40342. The scanning is typically executed by deflecting the beam with an appropriate optical element, for example a fast-rotating mirror. One typical utilization of the scanning instruments is so that they are mounted on a fixed basis comprising at least one further motorized axis to change, measure and record the emission angle in two degrees of freedom. The location of the scanning instrument can be properly determined using known stationing methods, particularly based on appropriate matching of a multitude of point clouds. The point cloud thus delivered is referenced to the appropriate local or global coordinate system and can be merged with further data, including further point clouds.

Capturing a large point cloud, e.g. an entire construction site, based on a large number of individual scans from such stationary locations is not only cumbersome, but also requires extensive pre-planning to avoid blind spots and achieve the required coverage. Therefore, alternative approaches based on mobile scanning instruments and pose tracking have also been developed. Mobile scanning instruments in the sense particularly cover autonomous and/or remote-controlled robots, autonomous and/or remote-controlled unmanned aerial vehicles (UAV), autonomous and/or remote-controlled unmanned ground vehicles (UGV), wearable and/or handheld scanning instruments. Conventional geodetic surveying devices might also possess pose tracking options, e.g. EP 3 779 357 B1 discloses a geodetic surveying instrument with pose tracking capabilities.

Pose tracking might be performed with the aid of an external signal, particularly GNSS-or WLAN-based signal. However, this requires the availability of such external signals, which could be problematic, e.g. within a large building under construction. Therefore, having an internal pose tracking system, e.g. in the form of an inertial navigation system (INS), visual position tracking system (VPS) or visual-inertial positioning system (VIPS) is preferable. However, such systems determine position and orientation by integrating displacement and/or velocity and/or acceleration data and therefore drift by nature.

Providing control points with known position or pose data to reset such drifts is known in the state of the art. In some prior art methods adhesive markers are provided to well-accessible locations of the construction side. Respective positions of said adhesive markers are then determined using a high precision surveying instrument, such as a total station. The coordinate data and some identification data, e.g. a serial number of the marker, are then manually entered into a notebook. In these prior art methods, the notebook can be either a digital or a paper-based notebook. In a subsequent scanning the mobile scanning instrument uses these known markers to reset its drift. For that the data stored in the notebook must be added manually, either inline during the scanning process or subsequently during the data processing.

A disadvantage of the prior art method is that there are separate workflows for capturing control points and integrating the coordinates into the processing of mobile scanning data. Moreover, the process includes several manual steps which are time consuming and error prone. Particularly for handheld or wearable devices control points are introduced in the processing of the scanning trajectory but are difficult to add on-site. For automated scanning, e.g. by autonomous robots, integrating such control points is challenging.

### SUMMARY

In view of the above circumstances, an object of the present disclosure is to provide an improved scanning system and scanning method, by at least partially eliminating the manual steps.

A further objective of the present disclosure is an automated maintenance of the control point related information on the basis of the performed scanning action.

The disclosure relates to a surveying system for generating a point cloud representing a setting. The setting comprises a set of real-world objects and the point cloud represents their spatial extent and geometric relationship with each other. The point cloud might be a dense point cloud. In other words, the point cloud can be displayed and interpreted as a continuous surface. Particularly, the point cloud might enable the generation of derived two-or three-dimensional products, such as floorplans, building information models, pipe models etc. Point clouds within the meaning can be used in particular to obtain, directly or indirectly via such derived products, comparisons between the state of the setting at two different points in time in order to monitor a progress of the setting and/or to obtain comparisons between a planned state of the setting with the actual state of the setting in order to detect deviations from the planned setting.

The system comprises a plurality of surveying devices and a data management server. The plurality of surveying devices comprises a first and a second surveying device. The skilled person knows that the components of the system do not necessarily have to be located in close proximity to each other, in particular the data management server can be a system remote from the surveying instrument, e.g. located at company headquarters and/or at external providers of computer resources, particularly as a cloud computing resource. The data management server might be realized as a virtual cluster or by similar alternatives. Furthermore, neither the data management server nor the surveying instruments must be realized as unit elements but can consist of physically separate components. In particular, the surveying instruments can consist of external computing units or additional measuring elements, e.g. measuring poles or external tracking devices. It is also possible that the first and second surveying devices are used in different phases, i.e. they may not be communicatively connected to the data management server simultaneously, but in a sequential manner. Moreover, a surveying device or a field computer associated with it might act as a master device, both as a permanent master device or a temporarily master device. Such master device can provide partly or fully the functions associated with the data management server. In that case the surveying device might also be considered to be the data management server. Alternatively, a surveying device might act as a master communication interface and each communication with the data management server might be realized through this master communication interface. The present disclosure is not limited to any specific implementation.

For reasons of transparency and conciseness only embodiments in which a single first surveying device and a single second surveying device coupled simultaneously and in a continuous manner to the data management server will be described in detail. The features of alternative embodiments, particularly relating to one or more of the above-mentioned alternatives can be applied correspondingly.

The data management server is configured to store digital data about the setting. Said digital data comprise a set of control point data associated with a set of control points. The control point data comprise at least a unique identified (ID) and position data associated with a given control point. Preferably the positions data meets geodetic accuracy standards. An example of such geodetic accuracy standards are maintained by the Federal Geographic Data Committee (https://www.fgdc.gov/standards/projects/accuracy/). From here on the term “control point” will refer to real-world objects, such fiducial markers or cardinal features such as corners, and the term “control point data” will refer to such associated data. The control point data can be processed by the surveying systems substantially automatically. The data management server is configured to update the set of control point data based on control point data received from the surveying devices. Updating the set of control point data might comprise an automatic distribution of said data to the plurality of surveying devices or to a subset communicatively coupled with the data management server.

The unique ID enables unambiguous identification of control points by surveying devices belonging to the surveying system. In other words, each unique ID associated with a control point of the set differs from any other unique IDs associated with further control points of the set. Unique IDs might be passively identifiable, e.g. they have a different visual appearance. Actively communicating unique IDs, such as RFID tags are also possible for a system. The unique ID might be based on a specific tag actively placed on the control point location, e.g. a marker glued to a surface and/or a symbol drawn on the wall, in particular an alphanumerical symbol such as a number. The unique ID can also be based on a pre-existing feature such as an image taken from a corner. Moreover, the unique ID might also comprise information regarding a coarse position of the control point, e.g. a corner of a window located in the second floor. The skilled person also understands that the data management server might assign a further, internal reference to the control points of the set allowing a querying of the control points.

Each surveying device comprises a communication unit for establishing data exchange with the data management server. In the following, only those embodiments are described in detail in which a possibility of uninterrupted communication between the data management server and the surveying device exists. The specific properties of further embodiments, e.g. wherein the communication is realized in batches are correspondingly applicable. Particularly, the surveying devices might download, store and process copies of parts of digital data representing the setting.

The first surveying device is configured (i) to generate a first control point and associate the first control point with first control point data comprising at least a respective first unique ID and first control point position data, and (ii) to send, using a communication unit of the first surveying device, the first control point data to the data management server. The data management server is configured to update the set of control point data based on the received first control point data. Generating a control point in the sense also covers the case wherein a pre-existing landmark is designated as a control point.

In other words, the first surveying device can be used to create data to generate or update the set of control point data. Updating in this context means extending the set of control points by the inclusion of the newly generated first control point. Further options to manage the sets of control points might also be possible and will be discussed later. By way of example, the unique ID might be an adhesive reference marker with an at least locally unique visual pattern. Locally unique in the sense means that the system and/or the setting comprise no further identical object. The unique visual pattern might be perceivable by both the first and second surveying devices. The unique visual pattern is distinguishable from the other visual patterns associated with further control points by said surveying devices. The reference markers might also comprise a reference area whose position is associated with control point. The reference area might also be identifiable by the surveying devices.

The skilled person understands that the control point data might also comprise timestamps representing time intervals during which given control point data can be utilized for pose correction of a scanning device, deriving point clouds or derivative data. By way of example, it is advantageous to regularly scan construction sites or industrial plants to monitor the changes. Some developments in the setting might lead to a shift of a control point. For such situations it is beneficial to store a control point with first coordinates valid in a first time interval and second coordinates valid in a second time interval. Thus, for processing point cloud data stemming from the first time interval the first coordinates might be used to represent the control point. For processing point cloud data stemming from the second time interval the second coordinates might be used to represent the control point. The skilled person understands that providing two sets of control points valid at different time intervals is essentially identical with the above-described workflow.

The first surveying device might be a high-precision surveying device such as a laser tracker, a total station or a global navigational satellite system (GNSS) receiver configured for high precision pose measurements, e.g. based on real time kinematics. Moreover, during the generation of such position data the first surveying device is operated in a manner to capitalize its higher precision. Particularly the device might be stationed thoroughly. The skilled person understands that cost and time efficiency are less important in this subtask than measurement accuracy, as only a few control points are generated which are then subsequently used to improve the measurement data generated by the further surveying devices.

The second surveying device comprises a pose determination unit providing pose data of the second surveying device and a scanning unit for deriving scanning data.

Scanning relates to the action of obtaining measurement data for the object points of the point cloud. In the particular case of laser scanners the scanning comprises an emission and reception of a scanning signal, particularly a laser pulse, and providing coordinate data for an object point, e.g. based on the emission angle(s) and the time of flight of the laser pulse. Scanning data in this sense represents raw measurement data or processed data used for the generation of the point cloud. The scanning unit represents the ensemble of hardware components, e.g. optical, electronic and mechanical components, and software components required for these operations. Scanning data in the sense is not limited to point clouds, let alone dense point clouds. The skilled person understands that a set of single point data provided by a geodetic surveying instrument, by way of example for providing anchor points for a point cloud, is also scanning data in the sense. A total station is an embodiment of such a system, which can deliver this type of high precision data as scanning data.

The pose determination unit in the sense might be an internal pose tracking unit providing pose data in real time. A surveying device configured to perform a stationing, e.g. determining its static pose by determining relative coordinate data of landmarks with known absolute coordinate data, also comprises a pose determination unit in the sense. Absolute data in the sense represents coordinate data referenced to the external reference system. Moreover, a terrestrial laser scanner delivering high-quality point cloud from which its acquisition pose can be backtracked, e.g. based on matching said point cloud with an external reference system, also comprises such pose determination unit. Even if the pose is only implicitly recorded in the sense that it is known that all the scan data is recorded from a given pose. The pose determination unit must not explicitly determine, let alone provide, the pose of the surveying device continuously during the surveying workflow. By way of example, only the embodiments, wherein the pose determination unit is embodied as a pose tracking unit will be described in more detail. The skilled person can apply the required modifications based on common general knowledge in case a different type of pose determination unit is used.

A pose tracking unit in the sense provides pose information for adjusting the above-mentioned scanning data to derive the point cloud. Pose tracking might be based on external tracking signals, such as GNSS signals or signals from laser tracking units, or they might be based on internal data such as data provided by INS or VPS. Owing to the signal independent nature systems which are based at least partly on internal data are advantageous where such external signals are difficult or impossible to provide. By way of example, from here on it is assumed that the tracked pose is provided on the basis of such internal data.

The second surveying device is configured to (i) to generate position data for a set of object points in the setting based on the scanning data and the pose data, (ii) to identify a second control point of the set of control points based on a second unique identifier associated with the second control point, (iii) to access, using a communication unit of the second surveying device, second control point position data associated with the second control point from the data management server, and (iv) to derive the pose data and/or an uncertainty of the pose data under consideration of a measured relative position of the second control point and the second control point position data.

It is clear for the skilled person that the above workflow contains both the cases, (i) when the control point related information is specifically queried from the data management server upon the identification of the control point, and (ii) when the server is pushing all available control point data to the second surveying device and the query takes place locally on the surveying device. A combination of the two might also take place, i.e. the server pushes a subset to the surveying device upon the identification of a specific control point, particularly a subset representing nearby control points. The latter might be especially advantageous, when the second unique ID comprises an image of the second control point and the identification is performed based on computer vision and/or image matching. Parsing through only the nearby visual features not only reduces the computational load but also reduces the risk of misidentifications.

The skilled person understands that the differentiation between the first surveying device with the first control point and second surveying device with the second control point is situational. The first surveying device generates information associated with the first control point while the second surveying device utilizes the information associated with the second control point. I.e. the same real world control point takes the role of a first control point when the associated information is generated or updated, and a second control point, when said information is provided for a surveying device for determining its pose. In the same manner the same surveying device might take the role of a second surveying device, when it utilizes the control points to determine its pose, whereafter it acts as a first surveying device when it generates new control points, particularly checkpoints.

While not limited to the present disclosure it is especially beneficial for mobile, e.g. wearable, handheld or self-propelling, survey devices with continuous pose tracking. Such pose tracking is often based on internal sensors which drift with time. Such sensor drift can be corrected by measuring the relative pose of the control point and comparing it with the known absolute pose. Measuring the relative pose of the first control point with respect to the second surveying device can be performed using the scanning unit, the pose tracking unit or an additional component. Particularly, if the control point is identified in the scanning data, the adjustment of the tracked pose can be performed on the fly and with the precision of the laser scanning data itself. Alternatively or additionally, the pose derivable from measuring the relative position of the control points might be use in a post-processing step to reconstruct the true scanning trajectory of the second surveying device. This reconstruction can comprise a back projection similarly to that of performed in part of a loop closure.

A subset of the control points might be used as checkpoints. The coordinates of the checkpoints might be known with lower precision than that of the further control points. Such checkpoints might be used for estimating an uncertainty of the pose data provided by the pose determination unit. The pose uncertainty data might be logical or similar data, i.e. only a true/false value or simplified numerical data is used to represent the pose uncertainty. By way of example, this might be carried out on the basis of line-of-sight measurements, i.e. whether the checkpoint is successfully located within a pre-defined cone of sight. Unless otherwise provided, the generic term control points cover the above-mentioned checkpoints also. Particularly any control point can be used as a mere checkpoint. Where distinction is required the non-checkpoint control points will be referred to as control points used in pose determination/adjustment. A part of the control points might be provided with lower measurement precision, particularly when said control points are used as checkpoints. The position data associated with the control points might comprise uncertainty data. Alternatively or additionally, the unique IDs might contain information regarding the nature of the control points, i.e. that they can only be used as checkpoints.

Performing adjustments on the fly and thus providing for the surveyor(s) on the field the correct pose is preferable. However nothing prevents corresponding synchronizing and/or timestamping the scanning data and tracked pose data and performing an adjustment during post-processing.

In some embodiments, the system further comprises a set of markers associated with the corresponding control points. Each marker comprises an optically perceptible area displaying data representing unique IDs of the respective control points. It is clear to the skilled person that each marker of the set is unique owing to the unique information provided by the corresponding optically perceivable areas. The markers, by their real-world pose, correspond to the control points and the unique optically perceptible areas correspond to the unique IDs. Owing to this correspondence the two terms might be used interchangeably, where this improves transparency and conciseness of the description.

Optically perceptible in the sense means that (i) imaging elements of the surveying devices, which include both targeting units, scanning units and auxiliary imaging units, are capable to acquire image data regarding said optically perceptible areas, and (ii) the surveying devices can automatically derive the unique IDs on the basis of said image data. Preferably said optically perceptible area comprises a machine-readable code, as they are less susceptible to damage. Nevertheless, the disclosure is applicable to cases where the optically perceptible area comprises alphanumerical symbols, or even handwritten notes, if the above requirements are fulfilled.

In some specific embodiments, the markers are embodied as sheets comprising a reflective layer on a first side and an adhesive layer on a second side opposite the first side. Alternatively or additionally, the markers comprise corresponding targeting areas, in particular embodied as a crosshair or a specific corner, configured to be targeted by the first surveying device during the determination of the first control point position data. Alternatively or additionally, the optically perceptible area is embodied as a barcode, or a QR code. In the sense, fiducial markers for augmented reality, computer vision or autonomous navigation, such as ARToolKit, ARTag, ArUco, AprilTag, WhyCon, WhyCode etc. markers, are considered to be modification of the QR-code type. QR-code in the sense, except when explicitly referred to the contrary, meant to include these types of markers also.

In some specific embodiments, each surveying device comprises an imaging unit. The imaging units are configured to acquire control point image data, particularly as photographic images, regarding the optically perceptible area. The data management server is configured to retrieve the data associated with the control points based on the control point image data. The image data might comprise data regarding the environment of the marker. This is especially useful when the second surveying device is carried by a human operator. By way of example, the location of the next control point might be displayed to the operator in the form of a visual guide, enabling the easy localization and identification of the control point. A further advantage of storing an associated image, particularly with environmental information, is that the degradation of the marker can be easily verified by comparing the stored image with the current state. Moreover, if the image comprises environmental information enabling the identification of the supposed location of the marker the non-presence of the marker can be determined with higher confidentiality.

In some specific embodiments, the first surveying device comprises an imaging unit. The imaging unit of the first surveying device is configured to acquire first control point image data regarding the optically perceptible area. The first control point data comprises the first image data and thus submitted to the data management server. By way of example, the data management server is configured to retrieve the data associated with the control points based on the control point image data. In other words, the first surveying device is configured to perform a generation of the control points in a manner that images regarding the control points are also provided in addition to the position data and the unique ID. Alternatively the image or a part of the image may act as the unique ID.

In some specific embodiments, the markers comprise corresponding alignment indicators indicating local coordinate systems of the markers. In particular the markers are embodied as fiducial markers, more particularly as ArUco markers. In such markers not only the position, but also the orientation representing said local coordinate system of the control point can be recorded. The second surveying device is further configured to access second control point orientation data. The second surveying device is configured to derive the pose data and/or an uncertainty of the pose data of the second surveying device further considering a measured relative orientation of the second control point and the second control point orientation data. The skilled person can modify any of the embodiments disclosed here in a straightforward manner for such cases. In some specific embodiments, the first surveying device is embodied as a total station. Total stations are known geodetic devices configured to provide coordinate data regarding single points with at least centimetric, particularly millimetric or better precision. Total stations essentially comprise targeting elements, single point distance measuring elements, in particular laser rangefinders, and angle sensors, with accuracy in the range of angular seconds. A targeting unit is understood to be an ensemble that can sight, aim, and measure one or more individual point, particularly control points. The targeting unit might be a single, integrated component of the total station, in particular co-axial sighting and single point distance measuring elements, in particular laser rangefinders.

To sight and target a designated target point, e.g. a crosshair of a reference marker, generic total stations are equipped with a telescopic sight such as optical telescope. The telescopic sight can be aligned with the target point by pivoting and tilting the total station. By way of example, such a sighting device is described in EP 2 219 011. The spherical coordinates of the target points are then determined. A distance of the targeted object is determined by a range finding method, in particular with a laser rangefinder, while elevation and azimuth angles might be derived from angle readings provided by the angle sensors comprised by the survey instrument, in particular comprised by the targeting unit.

The first surveying instrument can be an alternative instrument such as a laser tracker, or even a properly stationed terrestrial scanner.

In some embodiments, the second surveying device is configured to generate the position data for the set of object points during a continuous proper motion along a scan trajectory. In other words, the second surveying system is carrying out the scanning such that it has no fixed pose, particularly a fixed pose which is stationed as known in geodetic measurements. As such stationing is time consuming, performing the scanning in such manner is more time efficient. In particular, by providing automatically identified control points that can be used to reset the drift of the pose tracking data, the present disclosure enables such scans to be performed even more smoothly and naturally. Performing the identification of the control points and the resetting of the drift by remote sensing, e.g. image or laser-based measurements, is even more beneficial as an effort to approach the control points can also be reduced or ideally completely omitted. Alternatively, the drift might not be corrected, however it is monitored by checking the pose uncertainty, at least with respect to a line-of-sight direction. This can be performed by comparing the expected and measured relative position of known checkpoints based on the continuously tracked pose of the second surveying device and the known absolute position of the checkpoints.

In some specific embodiments, the second surveying device is configured (i) to be mounted to or integrated with a UAV and/or (ii) to be mounted to or integrated with a UGV, and/or (iii) to be mounted to or integrated with a mobile robot, and/or (iv) to be wearable by a human, in particular to be embodied as or mounted into a backpack or an exoskeleton, and/or (v) to be holdable by a single hand.

In some embodiments, the pose tracking unit comprises a VPS. In some specific embodiments (i) the VPS comprises a simultaneous localization and mapping functionality, and/or (ii) the VPS is configured to track the identified control points based on a visual tracking of the respective unique IDs, and/or (iii) the pose tracking unit further comprises an INS cooperating with the VPS. Having a VPS which can automatically recognize the control points and provide a tracking based on one or more control points with known absolute position is beneficial as the drift-free period of the VPS can be extended. Particularly for environments with many control points the second surveying device might have a constant line of sight with at least one control point for the majority of the scanning task.

In some embodiments, the set of control points comprises a subset of checkpoints. The second surveying device is configured to derive an uncertainty of the pose data under consideration of a measured relative position of one or more checkpoints.

By way of example, the above-mentioned mobile surveying device with pose tracking unit might quickly provide measured information regarding an uncertainty of the tracked pose. Such measured information might be obtained by comparing an expected relative position of the checkpoint with the observed position. Position in this sense might be limited to a direction of the checkpoint with respect to the second surveying device. No adjustment is performed using the checkpoints, thus position data associated with the checkpoints might be provided with lower accuracy than the rest of the control points. Particularly checkpoints might be pre-existing objects and/or might be provided by lower precision units, such as a laser scanner, and/or coordinates of checkpoints might be provided under less stringent conditions. Thus, orders of magnitude more checkpoints might be provided than control points usable for pose determination. Measuring the development of the pose uncertainty is beneficial for many aspects of the scan workflow. Particularly, it can be used to predict the pose uncertainty for future states with higher confidence than based on sensor characteristics alone. Thus, more efficient planning of the scan trajectory can be performed. Moreover, by recording the pose uncertainty a quality assessment on the acquired point cloud data can be performed. Advantageously, the higher quality data might be weighed more heavily than the lower quality data, during a stitching of the point cloud data from different sources.

In some specific embodiments, the system is configured to derive data regarding the scan trajectory based on an uncorrected scan trajectory constructed from the continuously tracked pose. By way of example, the second surveying device might record the continuously tracked pose and setup locations, where a measurement of a control point took place. Based on said measurements the true trajectory might be provided during post processing.

A potential workflow for the deriving of the scan trajectory comprises (i) moving the second surveying device along the scan trajectory, the scan trajectory comprising a first setup location and a second setup location, (ii) providing the unadjusted scan trajectory based on the continuously tracked pose data, the unadjusted scan trajectory comprising an unadjusted pose of the first setup location and an unadjusted pose of the second setup location, (iii) measuring the relative position of a third control point from the first setup location, (iv) deriving a pose of the first setup location based on the measured relative position of the third control point and third control point position data associated with the third control point, (v) deriving a first deviation based on the unadjusted pose of the first setup location and the pose of the first setup location, (vi) measuring the relative position of a fourth control point from the second setup location, (vii) deriving a pose of the second setup location based on the measured relative position of the fourth control point and fourth control point position data associated with the fourth control point, (viii) deriving a second deviation based on the unadjusted pose of the second setup location and the pose of the second setup location, and (ix) deriving the scan trajectory on the basis of the unadjusted scan trajectory, the first deviation and the second deviation using an error propagation function, in particular wherein the error propagation function is a linear error propagation function. Alternatively, the error propagation function might be derived based on a polynomial fit on a plurality of deviations between the true and unadjusted poses of a plurality of setup locations. In other words, the surveying device provides a continuously tracked pose during the movement along the scan trajectory. The drift of the unadjusted scan trajectory is then controlled at regular intervals and the true trajectory is then approximated based on these control measurements. The coordinates of the recorded object points are also adjusted in that manner. The skilled person understands that setup locations in the sense refer to the poses of the second surveying device from which such measurements are performed, i.e. they can be arbitrary points along the scan trajectory.

In some specific embodiments, the second surveying device is configured to generate position uncertainty data for a set of object points in the setting based on the scanning data, the pose data and the uncertainty of the pose data.

In some specific embodiments, the second surveying device is configured to perform an assessment based on an uncertainty threshold and the uncertainty of the pose data, and in particular approve a continuation of the collection of the scanning data.

In some embodiments, each of the plurality of surveying devices stores a unique device identifier associated with said surveying device. It is implicit from the purpose of said unique device identifier that it refers to digital data, which the surveying device can communicate to other surveying devices or the data management server. The unique device identifier might refer to the type of the surveying device, e.g. whether a respective surveying device is more appropriate for generating the control points or for performing the scanning. The unique device identifier might be an ex-factory identifier, enabling a backtracking of the history of the device. The unique device identifier might be locally assigned by the data management server.

The data management server stores the set of unique device identifiers. The data management server is also configured to perform a status check of a surveying device requesting communication with the data management server based on said set of unique device identifiers. The status check comprises (i) requesting, by the data management server, the unique device identifier of the surveying device communicating with the data management server, and (ii) denying the communication request of the surveying device if no data matching one of the unique device identifiers from the set of unique identifiers has been received from the surveying device within a time limit for the response. In other words, the inventive system can restrict data sharing to legitimate devices comprised by the system. As one primary use of the inventive system relates to large scale construction projects and/or industrial sites and/or large machinery the confidentiality of the data is often a central question.

In some specific embodiments, the status check is performed when the surveying device requests to contact the data management server and/or requests to access data stored in the data management server.

In some embodiments, a mobile computing device associated with the second surveying device. A mobile computing device might be realized as a field computer, a tablet, a smartphone, a general-purpose notebook or any suitable alternative. Such mobile computing devices are typically used for displaying various data. Key advantages, as compared to displays in the surveying device itself, that the size of the display can be larger, without making the surveying device itself cumbersome, or that data can be displayed independently of the activity performed by the surveying device. The mobile computing device is configured (i) to access position data associated with control points of at least a subset of the set of control points, (ii) to access the pose data of the second surveying device, and (iii) to display the pose of the second surveying device with respect to the position of the control points of the subset.

In some specific embodiments, the mobile computing device is further configured (i) to access or derive a navigation aid, particularly a map or a floorplan, regarding the setting, and (ii) to display the pose of the second surveying device and the pose of the control points of the second subset with respect to the navigation aid.

In some specific embodiments, the pose tracking unit is configured to provide an uncertainty regarding the tracked pose. Particularly the pose tracking unit might provide a warning message that the drift exceeds a threshold. It is beneficial to combine this embodiment with a navigation aid. The operator thus provided with the location of the nearest control point to reset the drift.

In some embodiments, (i) at least one of the plurality of surveying devices is configured to provide control point condition data relating to the perceivability of the unique ID, and (ii) the control point data comprises control point condition data. In some specific embodiments, the control point condition data is provided based on image data obtained by the imaging unit of the surveying device.

In some embodiments, the second surveying device comprises a contact area and configured to provide the relative position of the identified control point during touch contact between the control point and the contact area. Such embodiments are advantageous as direct contact between an appropriate element provides a reliable registration of the position of the contact area, particularly if the orientation of the surveying device is also fixed,. Such resetting of the drift, however, requires potentially cumbersome actions by the operator, which can also be time-consuming.

The present disclosure also relates to a method for providing a control point regarding a setting. The method comprises a provision of a set of control points and a recording of a point cloud.

The provision of the set of control points comprises (i) providing a first surveying device in communicative coupling with a data management server, (ii) measuring first position data by the first surveying device for a first control point preferably such that the position data meet geodetic accuracy standards, (iii) assigning first control point data comprising at least a first unique ID and first position data to the first control point, wherein the unique IDs are configured in such a way that they enable unambiguous identification of the assigned control points, (iv) communicating the first control point data to the data management server, and (v) based on the first control point data performing, by the data management server, at least one of (a) establishing a new set of control points, and (b) updating an existing set of control. It is clear for the skilled person that the data management server might store different sets of control points for different purposes. Thus, a control point of a first set might be remeasured and at the same time used for establishing a new set. Moreover, a part of the control points might be provided with lower measurement precision, particularly when said control points are used as checkpoints. The position data associated with the control points might comprise uncertainty data. Alternatively or additionally, the unique IDs might contain information regarding the nature of the control points, i.e. that they can only be used as checkpoints.

The recording of the point cloud comprises (i) providing a second surveying device in communicative coupling with the data management server, (ii) perceiving a second unique ID by the second surveying device, (iii) accessing at least a second position data of a second control point associated with the second unique ID, (iv) measuring a relative position of the second surveying device with respect to the second control point, (v) determining a pose and/or an uncertainty of the pose of the second surveying device under consideration of the measured relative pose of the second surveying device and the second position data, and (vi) measuring position data for a plurality of object points representing the setting by taking into account the determined pose of the second surveying device.

The above method is especially advantageous for the cases when the second surveying device is embodied as a mobile scanning instrument, which for the purpose includes both scanning devices mounted to a mobile platform or portable devices. Such devices typically have internal pose tracking instruments. The results of the inventive method can be used in two ways. In the first option the pose uncertainty is determined based on the expected and actual relative position of a checkpoint, said uncertainty is either recorded and further processed in determining the position uncertainty of the object points of the point cloud, or used as a qualitative measure, i.e. whether the pose uncertainty is within the tolerance limits. For that checkpoints whose position is known with a certain uncertainty might be applicable, provided that this uncertainty is below that of the tolerance limit. In the second option the pose uncertainty is corrected, particularly said correction can be back projected, thus the tracked scan trajectory is corrected to better reflect the actual trajectory. The second option requires control points whose real-world position is known with great precision.

The use of mobile scanning instruments is known from the prior art. Deriving point coordinates in the reference system comoving with the scanning device and transforming into an outside reference system based on a tracked pose is also known as such. As there are many alternatives for both, only specific examples will be mentioned in reference to the drawings. The skilled person is, nevertheless, based on the type of surveying device, can adapt the teaching to the selected pose tracking and scanning method.

The second surveying device might receive all control point related data from the data management server before and/or during the scanning action and perform the retrieval of the data internally. Alternatively, it might query the digital data which is stored on the data management server.

In some embodiments, the method further comprises an updating of a control point. Said updating of a control point comprises (i) accessing a pose of a surveying device, wherein the surveying device is configured to perceive unique IDs associated with control points, in particular as image data or on the basis of image data, (ii) accessing, by the surveying device, a set of control points and the associated position data and unique IDs, (iii) deriving a relative position of a selected control point based on the pose of the surveying device and accessed position data of a selected control point, (iv) obtaining perception data on the basis of the relative position of the selected control point, (v) determining control point condition data based on the obtained perception data, in particular wherein the control point condition data comprises data regarding the presence of the unique ID, (vi) communicating the unique ID and the control point condition data to the data management server, and (vii) based on the communicated unique ID and control point condition data performing, by the data management server, updating the existing set of control points or generating a new set of control points, in particular removing the selected control point associated with the unique ID from the set of control points or generating a set not comprising the selected control point, when the unique ID was missing from the perception data.

In other words, the surveying devices receive data regarding the expected location and/or condition of real-world elements of the control points, such as reference markers or RFID transceivers. The surveying device then determines whether the unique ID associated with a control point is perceivable and the perceived information corresponds to that of the expected unique ID. E.g. whether the reference marker is damaged and only a portion of the unique ID is retrievable. If the control point is not applicable anymore due to the above defects it is removed from the set of control points. Optionally a warning to generate a new control point is provided if the surveying device is a first surveying device. Alternatively, the existing set can be provided with a time stamp indicating that it is not applicable for processing point cloud data acquired after the time stamp. A new set of control points lacking the missing control point might be generated after.

The above-mentioned method is applicable, with corresponding straightforward alterations, to the cases wherein the control point is damaged in a manner that its unique ID has been altered, but still fulfils the criterion of a unique ID, or its position is shifted. The updated, or newly generated, set of control points would comprise the selected control point with is altered unique ID or position.

In some specific embodiments, the surveying device is the second surveying device, and the pose of the surveying device is the tracked pose of the second surveying device. An especially advantageous application of the inventive surveying system relates to the use of such mobile devices to monitor the state of the control points. As the devices configured to act as first surveying devices typically higher-end devices with higher prices they might be present in the setting only for limited amount of time. Thus, the ability to automatically manage the set of control points based on the feedback from lower-end surveying devices enables better planning of the scanning procedure.

In some embodiments, the data management server is configured to store a plurality of surveying projects and assigning surveying devices and sets of control points to each surveying project of the plurality of surveying projects. The skilled person understands that a large construction project or a survey of an industrial plant might comprise sub-projects, which are also surveying projects in the sense. The sub-projects might represent different stages, i.e. they relate to the same setting at different times. It is also evident that especially for such cases the surveying projects might overlap with each other, thus a given set of control points or surveying device might be attached to a plurality of such projects. As mentioned before, a given control point might be a part of a plurality of sets, particularly in a manner that the control point data comprise a time stamp relating to a time interval for which given control point data is applicable.

The method comprises (i) assigning at least one first surveying device and at least one second surveying device to at least one surveying project of the plurality of surveying project by the data management server, (ii) assigning a set of control points to the at least one surveying project, (iii) optionally generating or updating the first control point data, (iv) assigning the first control point to the assigned set of control points, (v) immediately updating the assigned set of control points and the at least one surveying project when the data management received the first control point data, and (vi) immediately providing to each of the at least one second surveying device assigned to the at least one surveying project the updated set of control points. The skilled person understands that the same workflow is applicable for the cases where control point data of a selected control point is modified or the selected control point is deleted.

Any numbering and lettering in this document, and particularly with regard to the inventive methods, shall not be construed to imply a sequence, a given temporal or spatial relationship. Such numberings are presented solely for the purpose of improving readability. It is also clear that the method steps can be performed in alternative manner. Particularly, the assignment of devices and control points to a surveying project can be performed in a separate act. Moreover, the provision of the control points and the generation of the point cloud might be performed as two or more distinct actions. Particularly for scanning a large object the generation of the point cloud might require multiple days.

### BRIEF DESCRIPTION OF THE DRAWINGS

By way of example only, specific embodiments will be described more fully hereinafter with reference to the accompanying figures, wherein:

FIGS. 1a-e show different embodiments of prior art surveying instruments;

FIG. 2 shows schematically a step of generating the first control point by a first surveying device;

FIG. 3 shows schematically a generation of the scanning data by a second surveying device;

FIG. 4 schematically depicts a mobile computing device displaying the tracked pose of the second surveying device with respect to the position of the control points;

FIG. 5 shows a high level schematic representation of the data exchange in an embodiment of the inventive system.

FIG. 6a shows schematically, by a flowchart, the generation of a first control point.

FIG. 6b shows schematically, by a flowchart, the rectification of the tracked pose of the second surveying device.

FIG. 7a shows schematically the application of control points to correct a scanning trajectory of a mobile scanning device;

FIG. 7b shows schematically the application of checkpoints to monitor the pose uncertainty of a mobile scanning device;

FIG. 8 shows schematically the data communication during an update of a surveying project.

### SPECIFIC EMBODIMENTS

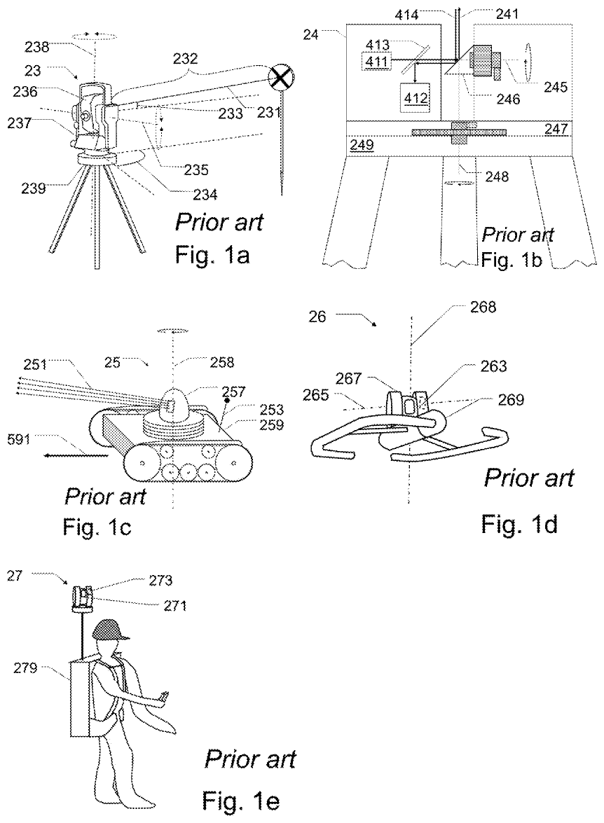

FIG. 1a shows a prior art surveying instrument embodied as a total station 23 generating single point measurement data by emitting a measuring beam 231, e.g. a laser beam. The total station 23 comprises a basis 239 providing a stable pose, which can be determined by known means, e.g. by measuring the relative coordinates with respect to known reference points. A frame 237 is mounted to the base 239 such that it is pivotable about a first axis 238. Typically, the total station 23 is levelled during a measurement, i.e. the first axis 238 is vertical. A targeting unit 236 is mounted to the frame 237 such that it is pivotable about a second axis 235. The second axis 235 is typically orthogonal to the first axis 238. The corresponding first angle 234 representing a rotation about the first axis 238 and the second angle 233 representing a tilting about the second axis 235 is provided by respective motorized components and measured by corresponding encoders. The targeting unit 236 comprises sighting elements and the hardware and software components enabling the aiming of the targeting unit towards a selected object in the setting. The targeting unit 236 is configured to emit a measuring beam 231 and to determine a distance 232 of a targeted object from the total station 23 based on a reception of a reflected signal from the object. Time of flight measurement of an emitted and reflected laser pulse is often used to determine the distance, but other alternative means are also applicable. The single point measurement data comprises a distance 232 from the total station 23, the first 234 and second angles 233. Owing to the setup and measurement methods total stations 23 are particularly suitable to act as a first surveying device.

FIG. 1b shows a schematic embodiment of prior art surveying device embodied as a stationary laser scanner 24. The laser source 411, configured to emit periodic pulse trains. Periodic pulse trains for such instruments also comprise pulse trains modulated with a further periodic or a random modulating signal. The stationary laser scanner 24 comprises a support unit 247 mounted to a base 249 such that it is rotatable about a first axis 248 by a motor. The depicted stationary laser scanner 24 comprises a transmission unit with a rotating mirror 246, which can be rotated about a second axis 245 by a corresponding motor. The transmission directions of the emitted laser pulse 241 thus depends on a first angle between the basis 249 and the support unit 247 and a second angle relating to a rotation state of the rotating mirror 246. The stationary laser scanner comprises the corresponding angle measuring sensors to provide the first and second angles. The reflected pulses 414 coming from directions of object points are first redirected by the rotating mirror 246 towards the internal volume of the laser scanner 24. A semitransparent mirror 413 redirects the return pulses 414 towards the acquisition unit 412. Instead of a semitransparent mirror 413 a mirror with a specific transmission zone and a specific reflection zone might also be utilized, in particular a mirror with a hole as transmission zone.

FIG. 1c shows a schematic embodiment of a prior art surveying device embodied as a UGV 25. The depicted surveying device comprises a mobile frame 259, capable of autonomous movement 591. The surveying device 25 comprises a scanning unit 257, in the depicted embodiment a profiler type scanning unit pivotable about a single axis 258, for deriving scanning data. The depicted scanning unit 257 is a multi-beam scanning unit projecting a plurality of scanning beams 251. Multibeam systems are known from the prior art, e.g. EP 3 816 657 A1 discloses such a system, the teaching of which is incorporated by reference. The coordinates of object points in the setting are thus determined based on the rotation state of the scanning unit 257, the pose of the mobile frame 259 and a distance measurement based on processing the emitted and returned signals of the measurement beam 251. The latter might comprise a step of associating the different bundles of emitted and return beams with each other. As the pose of the mobile frame 259 is paramount for the measurement the depicted system comprises a pose tracking unit 253, depicted as a tracking target for an external laser tracker.

FIG. 1d shows another prior art surveying device 26 embodied as a UAV. The support unit 269 on which the scanning element 267 is mounted is embodied as a drone. The depicted scanning element 267, while some specific properties are optimized for use with aerial vehicles, is in broad terms similar to the static terrestrial scanning device as shown in FIG. 1b. Particularly the scanning beam is pivotable about two, particularly orthogonal, axes 265,268 in a manner described with respect to FIG. 1b. As the pose of the drone 269 is paramount for the measurement the depicted system comprises a pose tracking unit 263, depicted as an INS.

FIG. 1e shows a prior art surveying device embodied as a wearable lidar 27, having a backpack 279 as support unit. The backpack 279 can be carried by the surveyor whom thus has her hand free to perform further activities. For the sake of simplicity the scanning unit 271 and the pose tracking unit 273 are assumed to be functionally similar to the previous embodiments.

The devices depicted in FIGS. 1b-1e, owing to their scanning nature are particularly suited for the role of a second surveying device. The skilled person understands that various combinations and alterations of these examples are possible. Moreover, while these devices are shown as examples of generic contemporary surveying devices, after suitable modifications, they can be utilized in the inventive system, respectively perform a corresponding step of the inventive method.

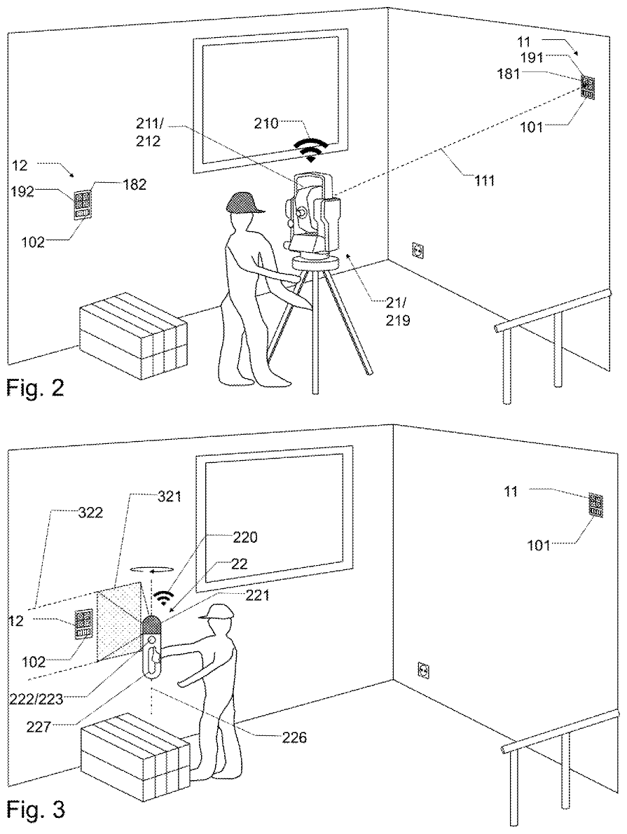

FIG. 2 shows schematically a step from generating the control point data by a first surveying instrument 21, depicted as a total station. The depicted setting, by way of example a part of a building under construction, shows two control points 11,12 with respective unique IDs 101,102. The depicted control points 11,12 are adhesive markers sheets with reflective layer 191,192 having a crosshair 181,182 on the first side and an adhesive layer opposite side. The unique IDs 101,102 are depicted here as bar codes, such bar codes are visually perceivable and readable by respective detection system 212. Adhesive markers, such as ArUco markers, without a layer with enhanced reflectivity are also known in the prior art and applicable with the present disclosure.

In the depicted embodiment control point 11 can be considered as a first control point 11. FIG. 2 depicts the step, when the first surveying device 21 measures first control point position data 111. This is done such that the first surveying device 21, as a total station, is aligned with a specific element, in this embodiment the crosshair 118, representing the first control point 11. The targeting unit 211 registers its alignment and the distance between the first control point 11 and the first surveying device 21, e.g. by measuring the time of flight of a laser pulse between the first surveying device 21 and the first control point 11. The first control point position data 111 associated with the first control point 11 is generated based on the above data and the known current pose 219 of the first surveying device 21. The first surveying device 21 sends, using its communication unit 210, the first unique ID 101 and the first control point position data 111 to the data management server as first control point data. The first control point data might comprise further data, particularly metadata regarding the measurement conditions, image data or an identifier of the first surveying device 21. The first control point position data 111 might comprise a position uncertainty. By way of example, only control points whose position data fulfills certain accuracy requirements, particularly geodetic accuracy requirements, might be used for adjusting or deriving a pose of a second surveying device. The data management server, depending on the task, might establish a new set of control point data or update an existing set using the first control point data.

FIG. 2 shows a situation wherein said control points 11,12 are already adhered to the wall, this might have been performed immediately precedent to the depicted measurement step. Alternatively, the control points 11,12 are part of a pre-existing set of control points. In the depicted embodiment an operator registers the control points 11,12 however nothing prevents a partly or fully automated registering.

Similar steps might be performed when the first surveying device 21 determines its current pose 219. E.g. the control points 11,12 can be assumed to belong to a first subset of control points with known position and within line of sight from a current pose 219 of the first surveying device 21. By using the detection system 212 the first surveying device 21 identifies the control points 11,12 based on the unique IDs 101,102. Using the communication unit 210 of the first surveying device 21, the first surveying device 21 accesses position data associated with a control points stored at the data management server. By measuring its relative pose with respect to the control points 11,12 the first surveying device 21 can determine its current pose 219. E.g. EP 4 312 000 A1 discloses a method of deriving the pose of a stationary geodetic surveying device based on the measuring of a relative pose with respect to a plurality of reference markers with known (absolute) position. Said document, particularly the steps mentioned from Para [0028]-[0030], are hereby incorporated by reference. As the skilled person notices the depicted first surveying device 21 would have acted as a second surveying device, when performing the stationing steps.

FIG. 3 shows schematically the step of acquiring the scanning data by the second surveying device 22. The depicted second surveying device 22 is a portable scanner with a single rotational degree of freedom. The scanner comprises a support unit 227 configured to be held by the surveyor and a scanning unit 221 which is pivotable about an axis 226 of the support unit 227. The depicted scanning unit 221 is a multibeam unit projecting a plurality of laser beams to a scanning window 321. The scanning of the whole setting is performed by pivoting of the scanning unit 221 about the axis 226 of the support unit 227 as well as by moving the surveying device 22 along a scanning trajectory. Both actions displace the scanning window 321 and produce a trace 322 of scanned area. To gain the required own pose information such second surveying device 22 comprises a pose tracking unit 223. In the depicted embodiment the pose tracking unit 223 is a VPS utilizing images collected by an imaging unit 222. The scanning data corresponds to angular data associated with a relative orientation of the scanning unit 221, data representing the geometry of the scanning window 321 distance data representing distances of object points in the scanning window from the scanning unit 221. Position data for a set of object points in the setting is derived based on the scanning data and the tracked pose. Alternative portable scanner types, e.g. with fixed geometry and triangulation or photogrammetry-based evaluation are also known. The specific aspects of such scanners, particularly the way the scanning data is generated, are correspondingly applicable to the disclosure.

The inventive second surveying device 22 is configured to identify a second control point 12 based on the perceived unique IDs 102. In the depicted embodiment this is performed as a result of observing, by the imaging unit 222, the visually perceivable unique IDs 102 visited during the scanning action. The second surveying device 22 accesses, particularly using a communication unit 220 of the second surveying device 22, pose data associated with a second control point 12 from the data management server. In some embodiments the control point data is accessed beforehand, and the second surveying device 22 can retrieve said data using its internal memory. A relative position of the second control point 12 with respect to the second surveying device 22 is then determined, preferably this step is performed on the fly and in real time, however this step can also be carried out during a post-processing of tagged data. The relative position might be derived using a measurement by the scanning 221 or by the imaging unit 222. The tracked pose of the second surveying device 22 is adjusted based on the measured relative position of the second control point 12 and the position data associated with the second control point 12.

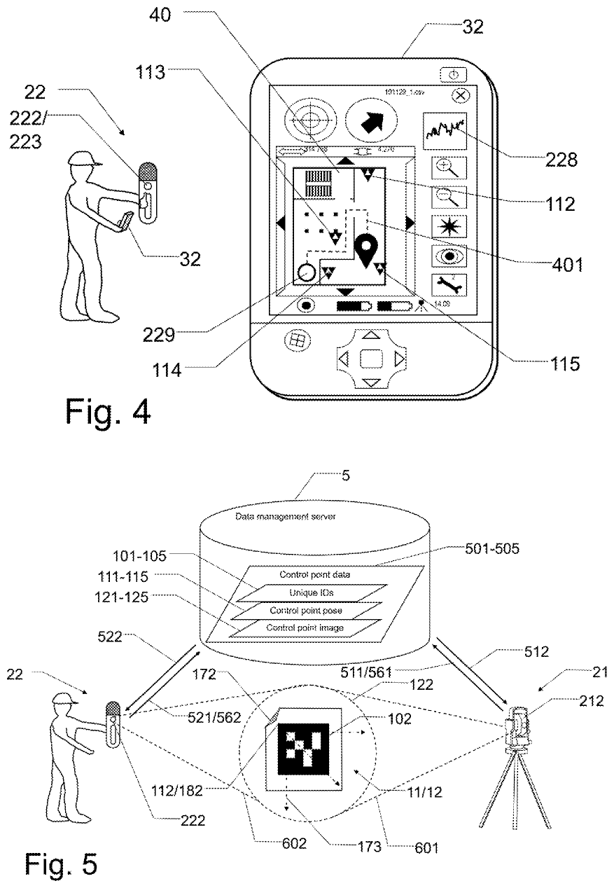

FIG. 4 shows an operator carrying a second surveying device 22, embodied as a handheld laser scanner, in a setting. The second surveying device comprises an imaging unit 222 providing imaging data for a pose tracking unit 223, depicted as a VPS or VIPS, providing tracked pose 229 of the second surveying device 22. The surveying system also comprises a mobile computing device 32 associated with the second surveying device 22. The mobile computing device 32 displays a navigational aid 40 regarding the setting. The navigational aid 40 comprises the position 112-115 of the control points of a subset. The depicted mobile computing device 32 also displays the tracked pose 229 of the second surveying device 22. The depicted mobile computing device also displays a scan trajectory 401 for completing the surveying task. The scan trajectory 401 might be calculated by talking into account the poses 112-115 of control points of the subset. Particularly the pose tracking unit 223 might calculate an uncertainty 228 of the tracked pose 229, e.g. based on the known drift characteristics of the sensors or based on the observed position of checkpoints (not shown). The scan trajectory 401 might be altered by taking into account said uncertainty 228. Particularly an approach of a control point might be planned if the uncertainty 228 exceeds a threshold.

FIG. 5 illustrates some key elements of the inventive system and method, which are the data management server 5, one or more first surveying device 21 (only one is shown for transparency reasons), one or more second surveying device 22 (only one is shown for transparency reasons), and a control point both in the role of a first 11 and second control point 12. The depicted control point 11/12 is marked by specific markers such as the depicted ArUco marker. The first 21 and second surveying devices 22 are in communicative coupling 511,512,521,522 with the data management server 5. I.e., they can retrieve 512,522 from or provide 511,521,561,562 data for the data management server 5. Preferably data communication is maintained during a performance of the actual survey task. However, the present disclosure is applicable in combination with offline batch data transfer, i.e. wherein the survey devices retrieve 512,522 and store their internal data storage unit the necessary data before performing the survey task and provide 511,521 the collected survey data after the completion of said task.

The data management server 5 stores digital data about the setting. Said digital data comprise a set of control points data 501-505. In the depicted embodiment each control point is associated with a unique ID 101-105, with position data 111-115 and an image 121-125 regarding the control point. The position data 111-115 might comprise uncertainty information. The digital data might comprise further data, particularly it can comprise planning data regarding the setting, particularly in computer aided design or building information model format. The digital data might comprise a set of images and/or point cloud data collected regarding the past or current state of the setting.

By way of example, the control points might be represented by an ArUco marker. Such fiducial markers have a unique ID 102 enabling the identification of the control point 11/12. The unique ID 102 is created such that alignment indicators 173 indicating a local coordinate system of the marker are observable. I.e. the black and white squares are arranged such that two orthogonal directions defining a plane and a third direction at the angle bisector is perceivable. Based on this information the top left corner of the marker, which is the targeting area 182 whose position 112 is associated with the control point 11/12, can also be identified. The depicted marker is an adhesive marker, having an adhesive layer 172 on the backside.

The depicted first surveying device 21 comprises an imaging unit 212 configured to acquire 601 an image 122 relating to the control point 11/12. Said image data 122 is provided 561 to the data management server 5. The image data 122 might comprise or act as the corresponding unique ID 102. The first surveying device 21 can also generate a first control point 11, e.g. in the manner as shown in FIG. 2, and provide 511 the corresponding first control point data to the data management server 5.

The second surveying device 21 can retrieve 522 at least a part of the control point data 501-505, particularly when performing a pose determination using a second control point 12 and/or when verifying the condition of a specific control point. The second surveying device 22 comprises an imaging unit 222 configured to acquire 602 an image 122 relating to the second control point 12. Said image data 122 can be communicated 562 to the data management server 5 to identify the control point 12 and retrieve 522 the corresponding position data 112. Alternatively, the image data 122 might be provided to verify the condition of the marker 12 and communicate 562 this piece of information to the data management server 5. In the case shown, part of the adhesive layer 172 is detached, but the unique ID 102 is still intact.

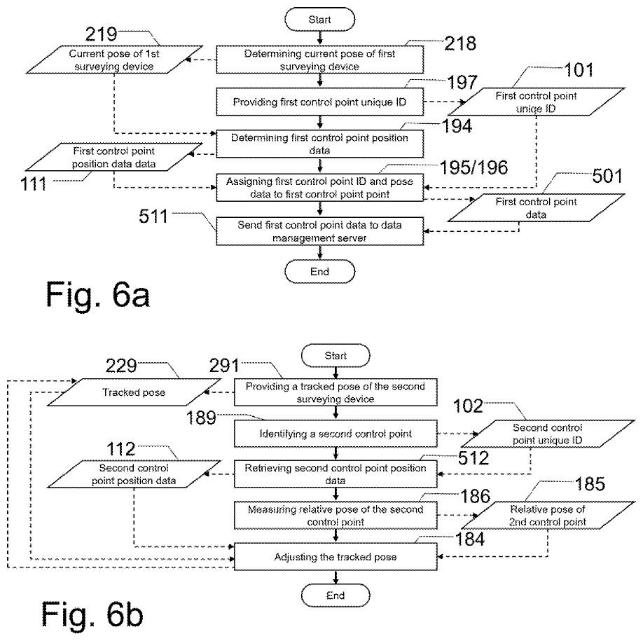

FIG. 6a shows by a flowchart the steps of generating a first control point and the associated first control point data 501. Flow/command lines are shown with bold while data lines are shown with dashed lines. Some flow-and/or data lines might not be shown in the schematic flowchart for transparency reasons. While the execution of some steps depends on the availability of certain data, reasonable variations in the sequence is possible. In the first step, the first surveying device determines 218 its current pose 219 using known pose determination means. These include the measurement of the distance and orientation of at least two control points or determining the orientation of at least three control points. The first surveying device might have a pose tracking unit providing a coarse tracked pose. Knowing the absolute pose is not strictly necessary for some workflows, particularly if a terrestrial laser scanner provides the first control point data 501, said pose information can be derived from the context at a later stage. The skilled person can adapt the depicted method for such cases based on common general knowledge.

Using the known current pose 219 of the first surveying device first control point data 501 can be generated. The data assigned 195/196 to the first control point data 501 will be transmitted 511 to the data management server. The physical first control point might be a pre-existing control point, e.g. a marker or a cardinal feature of the setting, particularly the first control point might comprise a first unique ID 101. The generating of the first control point/first control point data 501 in that sense corresponds to the collection of the required data. Alternatively, the physical first control point might be newly generated, e.g. a new marker is printed and placed on a desired location. The printer could be mounted or integrated with the first surveying device. The generation of the first control point data 501 comprises the performing, in sensible order, the steps of (i) determining 194 first control point position data 111, (ii) assigning 195 the first control point position data 111 to the first control point data 501, (iii) providing 197 a first unique ID 101, and (iv) assigning 196 the first unique ID 101 to the first control point data 501. The first unique ID 101, particularly for control points based on cardinal features of the setting, might be embodied as or comprises an image.

FIG. 6b shows schematically the steps required for adjusting 184 the tracked pose 229 of a second surveying device. A(n initial) tracked pose 229 is provided 291 by the pose tracking unit, e.g. based on an image based simultaneous localization and mapping method. A second control point is then identified 189 by detecting its unique ID 102, e.g. observing a bar code corresponding to the second control point. Next the second control point position data 112 is retrieved 512, particularly from the data management server, based on the second unique ID 102. Then the relative position 185 of the second control point to the second surveying device is measured 186. The skilled person understands that the relative pose of the second surveying device to the second control point is an equivalent measure. Based on the (absolute) position 112 of the second control point, the measured relative position 185 and the tracked pose 229 the tracked pose 229 is adjusted 184. Particularly the corresponding filters of the pose tracking units are reseted.

As mentioned before alternatives of the above workflow are also possible. Particularly the second surveying device might perform a stationing based on the control point data. The stationing might be performed based on point cloud stitching, wherein the point cloud comprises the control points as anchor points. Moreover, the above-mentioned data retrieval 512 can be performed based on data store in the memory of the second surveying device.

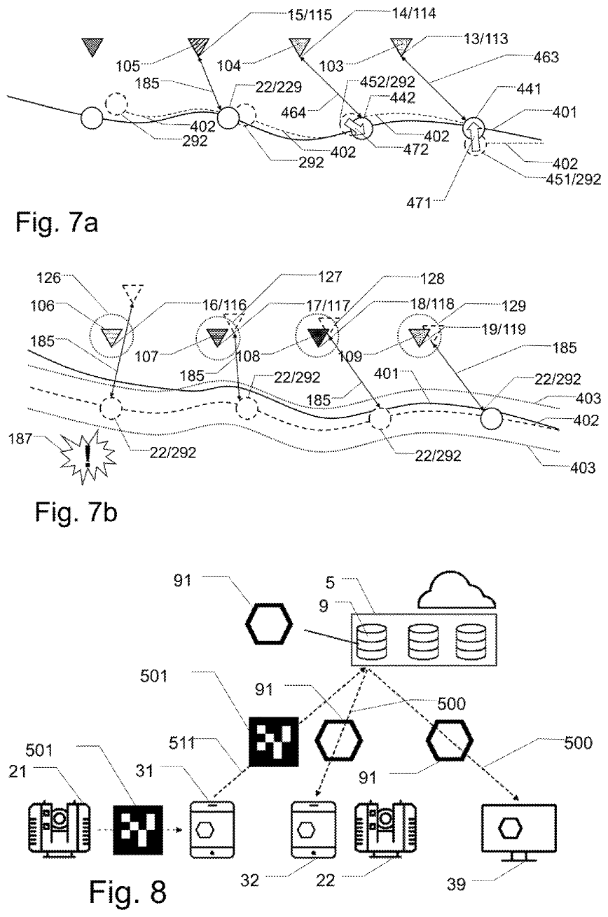

FIG. 7a shows schematically an embodiment of using a subset of control points 13-15 to determine the pose 229 of a second surveying device 22, propagating along a scan trajectory 401. By way of example, said scanning trajectory 401 represents a continuous proper motion. The skilled person can apply the teaching to the cases which involve scanning trajectories 401 comprising a set of individual setup locations 441,442. The control points 13-15 are associated with unique IDs 103-105, represented by the different filling pattern in the Figure, and known absolute position 112-115 which can be retrieved based on the acquired unique ID. The second surveying device 22 comprises a pose tracking unit (not shown) delivering uncorrected tracked pose data 292 and uncorrected scan trajectory 402. In the depicted embodiment the scan trajectory 401 is derived by controlling the deviations 471,472 between the unadjusted pose 451,452 of the setup locations 441,442, i.e. the corresponding tracked pose 292, and the pose derived by taking into account the measured relative position 463,464 of the control points 13-15. The development of the error can be approximated on the basis of the deviations 471,472, in particular if the control points are close enough to each other, a linear increase can be alleged.

The steps of the derivation of the scanning trajectory 401 comprises the moving the second surveying device 22 along the scan trajectory 401 with a first setup location 441 and a second setup location 442. The tracked pose 292 is provided during said moving and based on said tracked pose 292 an unadjusted scan trajectory 402 can be formed. At a first setup location 441, which can be an arbitrary point along the scan trajectory 401, a relative position 463 of a third control point 13 is measured. Based on this measured relative position 463 and the known absolute position 113 of a third control point 13, the pose data of the first setup location 441 can be derived. Based on the first setup location 441 and the unadjusted pose 451 of the first setup location, i.e. the associated tracked pose 292, a first deviation 471 can be calculated. In the depicted embodiment the first deviation 471 is used for resetting the drift of the pose tracking unit. This step is optional and the scan trajectory 401 might be derived afterwards in post processing.

The second deviation 472 associated with the second setup location 442, and can be provided in a similar manner based on the unadjusted pose 452 of the second setup location and the measured relative pose 464 of the fourth control point 14 and the associated fourth position data 114. A relative position 185 of a further control point 15 can be also measured from a further setup location and said measurement can also be utilized for deriving the scan trajectory 401.

FIG. 7b shows schematically an embodiment of using a set of checkpoints 16-19 to determine the pose uncertainty of a second surveying device 22, propagating along a scan trajectory 401. The true scan trajectory, marked with a solid line, is not known 401. In the depicted embodiment a pose tracking unit (not shown) provides a tracked pose 292 referenced to an external reference system. The sampling of the tracked pose 292 can be considered as essentially continuous and provided in between the depicted four points. From said tracked poses 292 an uncorrected trajectory 402, marked with a dashed line, is derived. For many surveying tasks the pose uncertainty of the surveying device 22, is not primary source of error for the point cloud coordinates, provided that difference between the true 401 and uncorrected scan trajectory 402 remains within a threshold 403. Such threshold 403 is represented by the dotted line. This condition can be verified by measuring the relative position 185 of the checkpoints 16-19 and comparing with the absolute positions 116-119.

The absolute position 116-119 of the depicted checkpoints 16-19 comprises a position uncertainty 126-129. Since the position measurements are not used for deriving the true scan trajectory 401 or to update the tracked pose 292 this has minimal disadvantage. Moreover, owing to the relaxed requirements checkpoints 16-19 can be created more easily than control points used for pose adjustment. By way of example, the position uncertainty 126-129 of the checkpoints 16-19 might be comparable with the above-mentioned pose uncertainty threshold 403 for the second surveying device. The checkpoints 16-19, as the further control points, are associated with corresponding unique IDs 106-109. In the depicted embodiment the second surveying device 22 measures a relative position 185 of the checkpoints. The second surveying device 22, then provides an assessment whether this relative position 185 is in compliance with the known absolute position 116-119, position uncertainty 126-129 and the tracked pose 292 of the second surveying device 22. If there is a correspondence the tracked pose 292 is approved, by lack of correspondence an error message 187 is provided. Alternatively or additionally, a numerical value regarding the pose uncertainty of the second surveying device 22 is determined, and particularly further utilized during a determination of the position uncertainty of the object points of the point cloud. In yet an alternative embodiment, a quality assessment is associated with the point cloud, and the stitching of the point clouds is performed under consideration of said quality assessments. In other words, the point clouds with lower pose uncertainty can be used to anchor the point cloud with higher pose uncertainty. The point cloud with higher pose uncertainty might be translated, rotated, and in particular strained to provide a matching.

FIG. 8 shows schematically the management for control point data by a data management server 5 containing a plurality of surveying projects 9 (only one is shown with reference signs). For each surveying project 9 at least one first surveying device 21 configured for generating control point data and at least one second surveying device 22 configured for utilizing said control point data are assigned. In the depicted embodiment the first 21 and second surveying device 22 are the same type. The skilled person understands that many alternatives are possible, e.g. more than two surveying devices, different types of surveying devices. Moreover, the surveying devices might change role and may act as both as first 21 and second surveying devices 22 at different stages of the surveying project 9. A set of control points 91 is assigned to the surveying project 9 and the surveying devices 21,22 assigned to the surveying project are enabled to access the surveying project data, particularly the assigned set of control points 91. A given surveying device or control point can be assigned to a plurality of surveying projects.

The first surveying device 21 generates a first control point data 501, represented by the unique ID, and provides 511 it to the data management server 5. In the depicted embodiment this is performed via a field computer 31 associated with the first surveying device 21. Generating the first control point data 501 also covers the cases, wherein said data is updated, particularly provided with a new time stamp. The data management server 5 updates the set of control points 91 assigned to the surveying project 9, when it receives the first control point data 501. Immediately thereafter the data management server 500 pushes the updates set of control points 91 to each of the second surveying devices 22 assigned to the surveying project 9. In the depicted embodiment this is realized via field computers 32 associated with said second surveying devices 22. Optionally the updated set of control points 91 can also be submitted 500 to an office computer 39 assigned to the surveying project 9.

Although aspects are illustrated above, partly with reference to some specific embodiments, it must be understood that numerous modifications and combinations of different features of the embodiments can be made. All of these modifications lie within the scope of the appended claims.

1. Surveying system for generating a point cloud representing a setting, the system comprising a plurality surveying devices and a data management server, wherein:
each surveying device comprises a communication unit for establishing data exchange with the data management server,
the plurality of surveying devices comprises a first surveying device being configured:
to generate a first control point and associate the first control point with first control point data comprising at least a respective first unique identifier and first control point position data, and to send, using a communication unit of the first surveying device, the first control point data to the data management server,
the data management server is configured:
to store digital data about the setting, said digital data comprising a set of control point data associated with a set of control points, the control point data comprising at least unique identifiers and position data associated with given control points, and
to update the set of control point data based on the received first control point data,
the plurality of surveying devices comprises a second surveying device comprising a pose determination unit providing pose data of the second surveying device and a scanning unit for deriving scanning data, wherein the second surveying device is configured:
to generate position data for a set of object points in the setting based on the scanning data and the pose data,
to identify a second control point of the set of control points based on a second unique identifier associated with the second control point,
to access, using a communication unit of the second surveying device, second control point position data associated with the second control point from the data management server, to derive the pose data and/or an uncertainty of the pose data under consideration of a measured relative position of the second control point and the second control point position data.

2. The system according to claim 1, further comprising a set of markers associated with the corresponding control points and each marker comprising an optically perceptible area displaying data representing unique identifiers of the respective control points, wherein:
the markers are embodied as sheets comprising a reflective layer on a first side and an adhesive layer on a second side opposite of the first side, and/or
the markers comprise a targeting area configured to be targeted by the first surveying device during the determination of the first control point position data, and/or
the optically perceptible area is embodied as a barcode or QR code or ArUco code, the markers comprise corresponding alignment indicators indicating a local coordinate system of the markers, and
the second surveying device is further configured to access second control point orientation data and to derive the pose data and/or an uncertainty of the pose data further considering a measured relative orientation of the second control point and the second control point orientation data.

3. The system according to claim 2, wherein the first surveying device comprises an imaging unit, wherein:
the imaging unit of the first surveying device is configured to acquire a first control point image data regarding the optically perceptible area, and
the first control point data comprises the first image data,
wherein the data management server is configured to retrieve the data associated with the control points based on respective control point image data, more particularly wherein the unique identifiers are based on the image data.

4. The system according to claim 1, wherein the second surveying device is configured to generate the position data for the set of object points during a continuous proper motion along a scan trajectory and the pose determination unit is configured to derive a continuously tracked pose, wherein the second surveying device is configured:
to be mounted to or integrated with an unmanned aerial vehicle, and/or
to be mounted to or integrated with an unmanned ground vehicle, and/or
to be mounted to or integrated with a mobile robot, and/or
to be wearable by a human, in particular to be embodied as or mounted into a backpack or an exoskeleton, and/or
to be holdable by a single hand.

5. The system according to claim 4, wherein the pose tracking unit comprises a visual positioning system, wherein:
the visual positioning system comprises a simultaneous localization and mapping functionality, and/or the visual positioning system is configured to track the identified control points based on a visual tracking of the respective unique identifiers, and/or
the pose tracking unit further comprises an inertial navigation system cooperating with the visual positioning system.

6. The system according to claim 4, wherein the pose tracking unit is configured to provide an estimated uncertainty regarding the pose data.

7. The system according to claim 4, wherein the system, the second surveying device and/or the data management server, is configured to derive data regarding the scan trajectory based on an uncorrected scan trajectory constructed from the continuously tracked pose, by:
moving the second surveying device along the scan trajectory comprising a first setup location and a second setup location,
providing the unadjusted scan trajectory based on the continuously tracked pose data, the unadjusted scan trajectory comprising an unadjusted pose of the first setup location and an unadjusted pose of the second setup location,
measuring the relative position of a third control point from the first setup location, deriving a pose of the first setup location based on the measured relative position of the third control point and third control point position data associated with the third control point,
deriving a first deviation based on the unadjusted pose of the first setup location and the pose of the first setup location,
measuring the relative position of a fourth control point from the second setup location, deriving a pose of the second setup location based on the measured relative position of the fourth control point and fourth control point position data associated with the fourth control point,
deriving a second deviation based on the unadjusted pose of the second setup location and the pose of the second setup location, and
deriving the scan trajectory on the basis of the unadjusted scan trajectory, the first deviation and the second deviation using an error propagation function, wherein the error propagation function is a linear error propagation function.

8. The system according to claim 1, wherein the set of control points comprises a subset of checkpoints (16-19) and the second surveying device is configured to derive an uncertainty of the pose data under consideration of a measured relative position of one or more checkpoints, wherein the second surveying device is configured:
to generate position uncertainty data for a set of object points in the setting based on the scanning data, the pose data and the uncertainty of the pose data, and/or
to perform an assessment based on an uncertainty threshold and the uncertainty of the pose data and approve a continuation of the collection of the scanning data.

9. The system according to claim 1, wherein:
each of the plurality of surveying devices stores a unique device identifier associated with said surveying device,
the data management server is configured to store the set of unique device identifiers and is configured to perform a status check of a surveying device requesting communication with the data management server, in particular when said surveying device requests to contact the data management server and/or requests to access data stored in the data management server, comprising:
requesting, by the data management server, the unique device identifier of the surveying device communicating with the data management server, and
denying the communication request of the surveying device if no data matching one of the unique device identifiers from the set of unique identifiers has been received from the surveying device within a time limit for response.

10. The system according to claim 1, further comprising a mobile computing device associated with the second surveying device, wherein the mobile computing device is configured:
to access position data associated with control points of at least a subset of the set of control points, to access the pose data of the second surveying device, and
to display the pose of the second surveying device with respect to the position of the control points of the subset,
wherein the mobile computing device is further configured:
to access or derive a navigation aid, particularly a map or a floorplan, regarding the setting, and
to display the pose of the second surveying device and the position of the control points of the subset with respect to the navigation aid.

11. The system according to claim 1, wherein:
at least one of the plurality of surveying devices is configured to provide control point condition data relating to the perceivability of the unique identifier, and
the control point data comprises control point condition data,
wherein the control point condition data is provided on the basis of image data obtained by the imaging unit of the surveying device.

12. The system according to claim 1, wherein the second surveying device comprises a contact area and configured to provide the relative position of the first control point during a touch contact between the second control point and the contact area.

13. A method for providing a point cloud regarding a setting, the method comprising a provision of a set of control points and a recording of a point cloud, wherein the provision of the set of control points comprises:
providing a first surveying device in communicative coupling with a data management server,
measuring first control point position data by the first surveying device for a first control point,
assigning first control point data comprising at least a first unique identifier and first control point position data to the first control point, wherein the unique identifiers are configured in such a way that they enable unambiguous identification of the assigned control points,
communicating the first control point data to the data management server, and
based on the first control point data performing, by the data management server, at least one of:
establishing a new set of control points, and
updating an existing set of control points,
wherein the recording of the point cloud comprises:
providing a second surveying device in communicative coupling with the data management server,
perceiving a second unique identifier by the second surveying device,
accessing at least a second control point position data of a second control point associated with the second unique identifier,
measuring a relative position of the second surveying device with respect to the second control point, determining a pose and/or an uncertainty of the pose of the second surveying device under consideration of the measured relative position of the second surveying device and the second control point position data,
measuring position data for a plurality of object points representing the setting by taking into account the determined pose of the second surveying device.

14. The method of claim 13 further comprising an updating of a control point, the updating comprising:
accessing a pose of a surveying device, the surveying device being configured to perceive unique identifiers associated with control points, wherein the surveying device configured to perceive the unique identifiers as image data,
accessing, by the surveying device, a set of control points and the associated position data and the unique identifiers,
deriving a relative position of a selected control point based on the pose of the surveying device and accessed position data of the selected control point,
obtaining perception data on the basis of the relative position of the selected control point,
determining control point condition data based on the obtained perception data, wherein the control point condition data comprises data regarding the presence of the unique identifier,
communicating the unique identifier and the control point condition data to the data management server, and
based on communicated unique identifier and control point condition data performing, by the data management server, updating the existing set of control points or generating a new set of control points, removing the selected control point from the updated set of control points or generating a set not comprising the selected control point, when the unique identifier was missing from the perception data.

15. The method according to claim 13, wherein the data management server is configured to store a plurality of surveying projects and assigning surveying devices and sets of control points to each surveying project of the plurality of surveying projects, the method comprising:
assigning at least one first surveying device and at least one second surveying device to at least one surveying project of the plurality of surveying project by the data management server,
assigning a set of control points to the at least one surveying project,
assigning the first control point to the assigned set of control points,
immediately updating the assigned set of control points and the at least one surveying project when the data management server received the first control point data, and
immediately providing to each of the at least one second surveying device assigned to the at least one surveying project the updated set of control points.

16. The method according to claim 14, wherein the data management server is configured to store a plurality of surveying projects and assigning surveying devices and sets of control points to each surveying project of the plurality of surveying projects, the method comprising:
assigning at least one first surveying device and at least one second surveying device to at least one surveying project of the plurality of surveying project by the data management server,
assigning a set of control points to the at least one surveying project,
assigning the first control point to the assigned set of control points,
immediately updating the assigned set of control points and the at least one surveying project when the data management server received the first control point data, and
immediately providing to each of the at least one second surveying device assigned to the at least one surveying project the updated set of control points.
